(19) United States
(12) Patent Application Publication
(10) Pub. No.: US 2026/0140277 A1
(43) Pub. Date: May 21, 2026

(54) INTEGRATED CALIBRATION TRANSCEIVER FOR DOWNHOLE TOOLS

(71) Applicant: Schlumberger Technology Corporation, Sugar Land, TX (US)

(72) Inventors: Daniel Fernandez, Houston, TX (US); Mark Frey, Houston, TX (US)

(21) Appl. No.: 19/201,365

(22) Filed: May 7, 2025

Related U.S. Application Data
(60) Provisional application No. 63/721,294, filed on Nov. 15, 2024.

(51) Int. Cl. G01V 13/00; G01V 3/30

(52) U.S. Cl. CPC G01V 13/00; G01V 3/30

(57) ABSTRACT

A calibration system includes a test loop placed over one or more antennas of a logging tool, an integrated calibration transceiver, wherein the integrated calibration transceiver is disposed in an electronic chassis of the logging tool, and a port disposed in the logging tool and configured to receive a connector of the test loop to connect the test loop to the integrated calibration transceiver, wherein the integrated calibration transceiver is configured to generate a test signal to drive the test loop and receive the test signal from the test loop.

### CROSS-REFERENCE TO RELATED APPLICATIONS

This application claims priority to and benefit of U.S. Provisional Patent Application No. 63/721,294, filed on Nov. 15, 2024, which is incorporated by reference herein in its entirety.

### BACKGROUND

The present disclosure generally relates an integrated calibration transceiver for downhole tools and a method for use thereof.

This section is intended to introduce the reader to aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological region is a remarkably complex endeavor. In many cases, decisions involved in hydrocarbon exploration and production may be informed by measurements from downhole well-logging tools that are conveyed deep into the wellbore. The measurements may be used to infer properties or characteristics of the geological region surrounding the wellbore.

Well logging tools, such as downhole tools, are utilized to measure well properties for well evaluation. These logging tools can include, for example, electromagnetic logging tools. The logging tools are typically utilized in conjunction with logging-while-drilling (LWD) operations or mapping-while-drilling operations in which formation evaluation measurements (e.g., resistivity, porosity, etc.) are taken during drilling operations. These measurements can be useful in providing, for example, bed boundary detection as well as delineation of reservoir boundaries and fluid contacts in a formation. However, the electromagnetic logging tools require careful calibration to produce accurate measurements.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some embodiments, a calibration system for performing calibration of a logging tool may include a test loop placed over one or more antennas of the logging tool, an integrated calibration transceiver installed on an electronic chassis of the logging tool, and an external port in the logging tool configured to connect the test loop to the integrated calibration transceiver. The integrated calibration transceiver may be configured to generate a test signal to drive the test loop and receive the test signal from the test loop.

In some embodiments, the calibration system for performing calibration of the logging tool may include the test loop, the integrated calibration transceiver installed on the electronic chassis of the logging tool, and external port in the logging tool configured to communicatively couple the test loop to the integrated calibration transceiver. The test loop may be placed over one or more antennas of the logging tool. The integrated calibration transceiver may include a controller configured to control the integrated calibration transceiver, a clock configured to perform synchronization operations, an amplifier configured to apply a gain to a signal, and a test loop/calibration select switch. The test loop may be placed over one or more antennas of the logging tool. The integrated calibration transceiver may be configured to generate a test signal to drive the test loop and receive the test signal from the test loop. The integrated calibration transceiver may also obtain calibration data regarding the one or more antennas.

In some embodiments, the system for performing calibration of the logging tool may include the logging tool, the test loop, the integrated calibration transceiver installed on the electronic chassis of the logging tool, and the external port in the logging tool configured to connect and communicatively couple the test loop to the integrated calibration transceiver. The logging tool may include one or more antennas, a processor, and a memory. The one or more antennas may include one or more transmitters, one or more receivers, one or more transceivers, or any combination thereof. The test loop may be placed over one or more antennas of the logging tool. The integrated calibration transceiver may be configured to generate a test signal to drive through the test loop and receive a test signal from the test loop. The integrated calibration transceiver may also be configured to obtain calibration data and store the calibration data in the memory of the logging tool. The processor of the logging tool may be configured to control the operations of the logging tool and the integrated calibration transceiver.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 depicts an example wellsite system for measuring borehole data using various downhole tools and surface tools, in accordance with embodiments of the present disclosure;

FIG. 2 depicts a well control system configured to control the wellsite system of FIG. 1, in accordance with embodiments of the present disclosure;

FIGS. 3a and 3b each depict an example of the logging tool of FIG. 1, in accordance with embodiments of the present disclosure;

FIG. 4 depicts a diagram of a calibration system generating and measuring a test signal used in conjunction with the logging tool of FIG. 3a or FIG. 3b, in accordance with embodiments of the present disclosure;

FIG. 5 depicts a second diagram of the calibration system of FIG. 4 receiving a test signal from the logging tool of FIG. 3a or FIG. 3b, in accordance with embodiments of the present disclosure;

FIG. 6 depicts a diagram of an integrated calibration transceiver of the calibration system of FIG. 4 performing self-calibration in conjunction with the logging tool of FIG. 3a or FIG. 3b, in accordance with embodiments of the present disclosure;

FIG. 7 depicts a flowchart of an embodiment for calibrating a receiver, in accordance with embodiments of the present disclosure; and

FIG. 8 depicts a flowchart of an embodiment for calibrating a transmitter, in accordance with embodiments of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Downhole tools often include antennas for taking electromagnetic measurements. For example, the antennas may be configured to measure the resistivity of the surrounding rock formation while the downhole tool is employed in drilling operations. However, calibrating the antennas can be a difficult process. The hardware traditionally used to calibrate the antennas is often large, expensive, difficult to apply, and interfaces poorly with calibration software. The hardware is also exposed to different conditions than the antennas, resulting in discrepancies between readings due to temperature and pressure differences. Present embodiments are directed to an integrated calibration transceiver disposed within the logging tool and a method of use thereof. Integrating much of the calibration hardware into the logging tool streamlines calibration process, facilitates communication between the calibration hardware and the other electronics of the logging tool, and eliminates discrepancies in measurements due to differences in temperature and pressure.

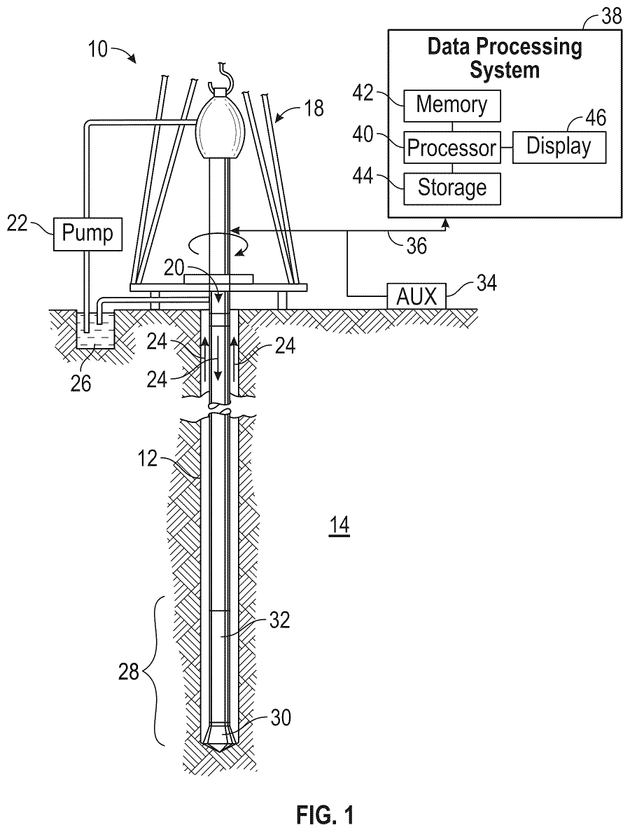

With the foregoing in mind, FIG. 1 illustrates a drilling system 10 that may employ the systems and methods of this disclosure. The drilling system 10 may be used to drill a borehole 12 into a geological region 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20 known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface.

The BHA 28 may include the drill bit 30 along with various downhole tools, such as one or more logging tools 32. The BHA 28 may thus convey the one or more logging tools 32 through the geological region 14 via the borehole 12. As described in greater detail herein, the one or more logging tools 32 may be any suitable downhole tool that emits electromagnetic waves within the borehole 12 (e.g., a downhole environment). The downhole tools, which may include the one or more logging tools 32, may collect a variety of information relating to the geological region 14 and the state of drilling in the borehole 12. For instance, the downhole tools may be logging-while drilling (LWD) tools that measure physical properties of the geological region 14, such as density, porosity, resistivity, lithology, and so forth. Likewise, the downhole tools may be measurement-while-drilling (MWD) tools that measures certain drilling parameters, such as the temperature, pressure, orientation of the drill bit 30, mapping-while-drilling tools, and so forth.

The one or more logging tools 32 may receive energy from an electrical energy device or an electrical energy storage device, such as an auxiliary power source 34 or another electrical energy source to power the tool. In some embodiments, the one or more logging tools 32 may include a power source within the one or more logging tools 32, such as a battery system or a capacitor, to store sufficient electrical energy to emit and/or receive electromagnetic waves.

Communications 36, such as control signals, may be transmitted from a data processing system 38 (processing system 38) to the one or more logging tools 32, and communications 36, such as data signals related to the results/measurements of the one or more logging tools 32, may be returned to the data processing system 38 from the one or more logging tools 32. The data processing system 38 may be any electronic data processing system that can be used to carry out the systems and methods of this disclosure. For example, the data processing system 38 may include one or more processors 40, which may execute instructions stored in memory 42 and/or storage 44. The memory 42 and/or the storage 44 of the data processing system 38 may be any suitable article of manufacture that can store the instructions. In certain embodiments, the one or more processors 40 may include a microprocessor, a microcontroller, a processor module or subsystem, a programmable integrated circuit, a programmable gate array, a digital signal processor (DSP), or another control or computing device. In certain embodiments, the one or more processors 40 may include machine learning and/or artificial intelligence (AI) based processors.

In certain embodiments, the memory 42 and storage 44 is implemented as one or more non-transitory computer-readable or machine-readable storage media. In certain embodiments, the memory 42 may include one or more different forms of memory, including semiconductor memory devices such as dynamic or static random access memories (DRAM s or SRAMs), erasable and programmable read-only memories (EPROM s), electrically erasable and programmable read-only memories (EEPROMs) and flash memories. The storage 44 may include solid state drives, magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) may be provided on one computer-readable or machine-readable storage medium of the memory 42 or the storage 44, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the storage 44 may be located either in the machine running the machine-readable instructions or may be located at a remote site from which machine-readable instructions may be downloaded over a network for execution.

As illustrated, the data processing system 38 may optionally also include a display 46, which may be any suitable electronic display, and may display images generated by the processor 40. The data processing system 38 may be a local component of the drilling system 10 (i.e., at the surface), within the one or more logging tools 32 (i.e., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. In some embodiments, the one or more logging tools 32 may store and process collected data in the BHA 28 or send the data to the surface for processing via communications 36 described above, including any suitable telemetry (e.g., electrical signals pulsed through the geological region 14 or mud pulse telemetry using the drilling fluid).

It should be noted that, although the discussion above relates to a drilling system, other downhole equipment or systems may employ the systems and methods of this disclosure. For example, a downhole tool with an acoustic tool conveyed by slickline, coiled tubing, wireline, or other delivery systems, may utilize the disclosed systems and methods.

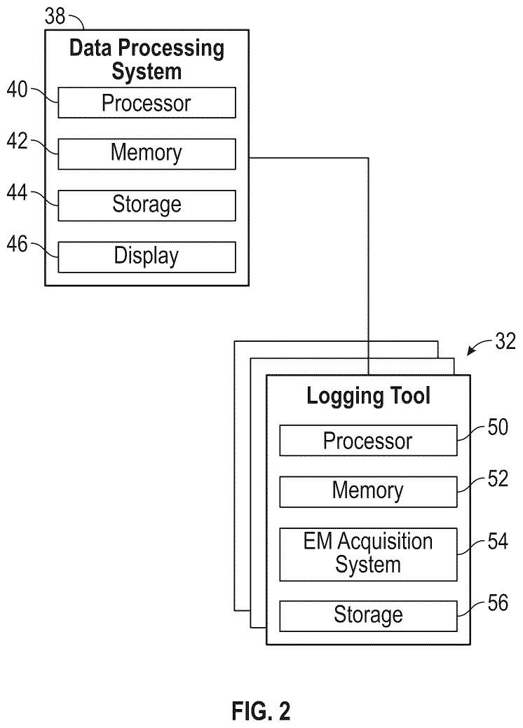

Operation of drilling system 10 may be controlled by a processor of the data processing system 38. For example, FIG. 2 illustrates a block diagram of the data processing system 38 that is communicatively coupled to the one or more logging tools 32. In the illustrated embodiment, a logging tool 32 includes a processor 50, memory 52, an electromagnetic (EM) acquisition system 54, and storage 56. In some embodiments, the processor 50 may be A SIC (application specific integrated circuit), field programmable gate array (FPGA), a micro control unit (MCU), a digital signal processor (DSP), and the like. In general, the drilling system 10 communicates with the data processing system 38 via a data cable, telemeter or other suitable techniques. For example, the drilling system 10 may communicate EM measurements obtained by an EM sensor (or meter) as part of the EM acquisition system 54. In turn, a processor of the surface control system may determine certain parameters (e.g., porosity, water saturation, permeability, velocities, resistivity, and so forth) based on the EM measurements. In such embodiments, the EM acquisition system 54 may include an emission source (e.g., an antenna) to acquire, obtain, or otherwise measure EM measurements.

In certain embodiments, the data processing system 38 may include one or more analysis modules (e.g., a program of computer-executable instructions and associated data) that may be configured to perform various functions of the embodiments described herein. In certain embodiments, to perform these various functions, the one or more analysis modules may executed on one or more processors 40 of the processing system 38, which may be connected to memory 42 and storage 44 in which the one or more analysis modules may be stored.

In certain embodiments, the computer-executable instructions of the one or more analysis modules, when executed by the one or more processors 40, may cause the one or more processors 40 to generate one or more models (e.g., forward model, inverse model, mechanical model, and so forth). Such models may be used by the processing system 38 to predict values of operational parameters that may or may not be measured (e.g., using gauges, sensors, and so forth) during well operations.

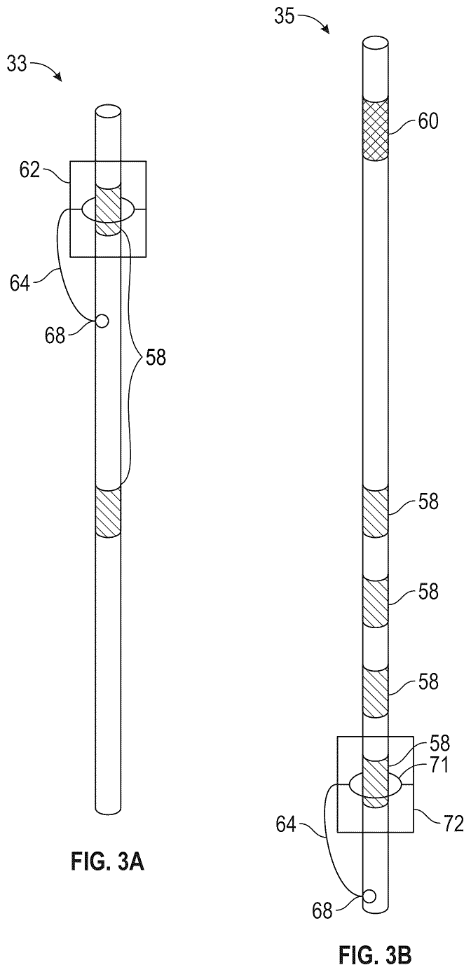

FIG. 3a illustrates an example of a logging tool 33 that can be utilized as one of the one or more logging tools 32 of FIG. 1. The logging tool 33 (e.g., tool 33), as illustrated, includes one or more antennas. However, it should be appreciated that the logging tool 33 may include any number of antennas. The antennas may act as a receiver 58, a transmitter 60, or a transceiver. In the illustrated embodiment, the antennas include two receivers 58 disposed along the tool 33. The antennas may each include a coil. Each coil of the antennas may be co-axial coils. The antennas can include tilted and/or transverse and/or axial coils. This results in mapping-while-drilling or LWD services that provide rapid and high delineation of reservoir layers and formation evaluation while drilling.

FIG. 3b illustrates another example of a logging tool 35 that can be utilized as one of the one or more logging tools 32 of FIG. 1. In the illustrated embodiment, the one or more antennas operate as a transmitter 60 as well as receivers 58 a disposed along the tool 35. The one or more antennas may act as one or more receivers 58, one or more transmitters 60, and/or one or more transceivers.

A calibration system may be employed when the antennas are being calibrated. The calibration system may include a test loop 62 and an integrated calibration transceiver installed on an electronic chassis of the tool 33 or 35. When the tool 33 or 35 is being calibrated, a test loop 62 may be placed over one of the one or more antennas to be tested. For example, in FIGS. 3a and 3b, the test loop 62 is placed over one of the receivers 58. The test loop 62 may be connected via a cable 64 to an external port 68 in the tool 33 or 35. The external port 68 may be configured to communicatively couple and/or connect the test loop 62 to the integrated calibration transceiver. The external port 68 may reduce the damage to the antennas caused by the calibration process by allowing easy access to internal electronics of the tool 33 or 35. The calibration system may function either in a receiver mode when used to calibrate the transmitter 60 or in a transmitter mode when used to calibrate the receiver 58. The calibration system may switch between receiver mode and transmitter mode without adjusting the connection between the test loop 62 and the integrated calibration transceiver. This provides an internal drive, measurement, and processing system that eliminates all external calibration hardware with the exception of the test loop 62, the cable 64, and the external port 68. Such an embodiment also allows for the integrated calibration transceiver to be present in the same environment as the tool 33 or 35 during calibration, while using the same systems to synchronize and communicate within the system as what is used downhole.

The calibration system may be configured to generate a test signal, receive the test signal, or both. The calibration system may demodulate and filter a calibration waveform from the test signal. The calibration system may be configured to cross-check the calibration process. For example, the calibration system may detect whether the test loop 62 has been placed in an area that is not proximate to the antenna to be tested based on the signal levels and frequencies received by the calibration system. As another example, the calibration system may be configured to analyze the test signal for high noise and interference before using the test signal for calibration. The calibration system may use the same methods of communication employed elsewhere in the logging tool 32. For example, the calibration system may communicate with the data processing system 38 via a data cable, telemeter or other suitable techniques. The calibration system may store the calibration data in the memory 52 and/or storage 56 of the tool 32. The calibration data may include the current driven through the test loop, the current driven through the transmitters, the voltage induced on the test loop, the voltage induced on the receivers, or any combination thereof. Additionally, the processor 50 of the tool 32 may perform further processing of the test signal.

The test loop 62 may include one or more coils configured to function as both a receiver and a transmitter. As such, the test loop 62 may either function as a receiver in a receiver mode or as a transmitter in a transmitter mode. The test loop 62 may include one or more sub-loops angularly offset from one another. For example, in the illustrated embodiment, the test loop 62 includes an axial sub-loop (hereinafter the X test loop) 70 and a traverse sub-loop (hereinafter the Z test loop) 72. Either or both sub-loop may be used to perform the calibration of the antennas.

The integrated calibration transceiver may be installed on the electronic chassis of the tool 32. Therefore, the integrated calibration transceiver may be in the same environment and temperature as the tool electronics driving and controlling the antennas, thereby facilitating the synchronization of the calibration system with the normal measurement system. The integrated calibration transceiver may include a printed wire assembly (PWA). The PWA may further include a controller, a direct digital synthesizer (DDS), an analog-to-digital converter (ADC), a clock, a current sensor, and/or a plurality of switches. In some embodiments, the controller of the integrated calibration transceiver may be the processor 50 of the tool 32. In some embodiments, the clock of the integrated calibration transceiver may also be used by the other electronics of the tool 32. In such an embodiment, the calibration system may work with the other electronics of the tool 32 to measure the test signal received when the transmitter 60 of the tool 32 is transmitting and to generate the test signal when the receiver 58 of the tool 32 is receiving. The integrated calibration transceiver may be configured to perform internal self-calibration. The integrated calibration transceiver may also use the power source of the tool 32. When the integrated calibration transceiver is not in operation, the integrated calibration transceiver may enter a low power mode or turn off to minimize power consumption.

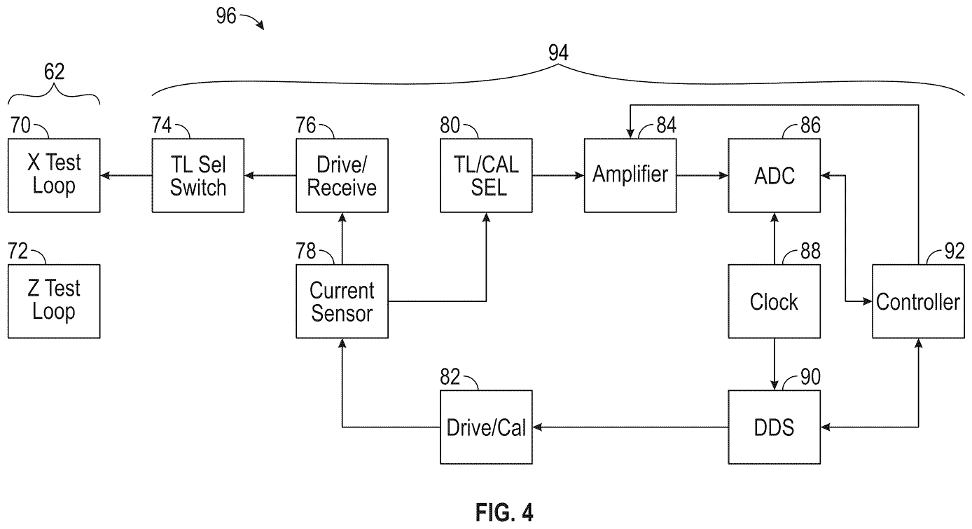

FIG. 4 depicts a diagram of the calibration system 96 generating and measuring a test signal used in conjunction with the logging tool of FIG. 3a or FIG. 3b. In particular, the diagram depicts the integrated calibration transceiver 94 generating the test signal, transmitting the test signal to the test loop 62, and measuring the current of the test signal. This operation may be performed when calibrating the receiver 58.

To begin, the test loop/calibration select switch 80 may be used to select a mode of operation of the calibration system 96. The calibration system 96 may operate in three modes: (1) receiver mode, wherein the calibration system 96 calibrates the transmitter 60, (2) transmitter mode, wherein the calibration system 96 calibrates the receiver 58, and (3) self-calibration mode, wherein the calibration system 96 calibrates the electronic gain of the amplifier 84 of the integrated calibration transceiver 94. In the illustrated embodiment, the test loop/calibration select switch 80 is set to receiver mode. When the calibration system 96 is in receiver mode, the test loop select switch 74 may be used to determine which sub-loop of the test loop 62 the calibration system 96 employs.

In the illustrated embodiment, a controller 92 outputs a command to the DDS 90 to generate the test signal. The test signal may have a known amplitude and phase. The test signal may extend across multiple frequencies. In some embodiments, the test signal may extend across the frequencies used to make the downhole measurements. The DDS 90 may provide the controller 92 an indication that it has generated the test signal. The drive calibration block 82 may feed the test signal from the DDS 90 to the current sensor 78. The current sensor 78 may measure the current of the test signal.

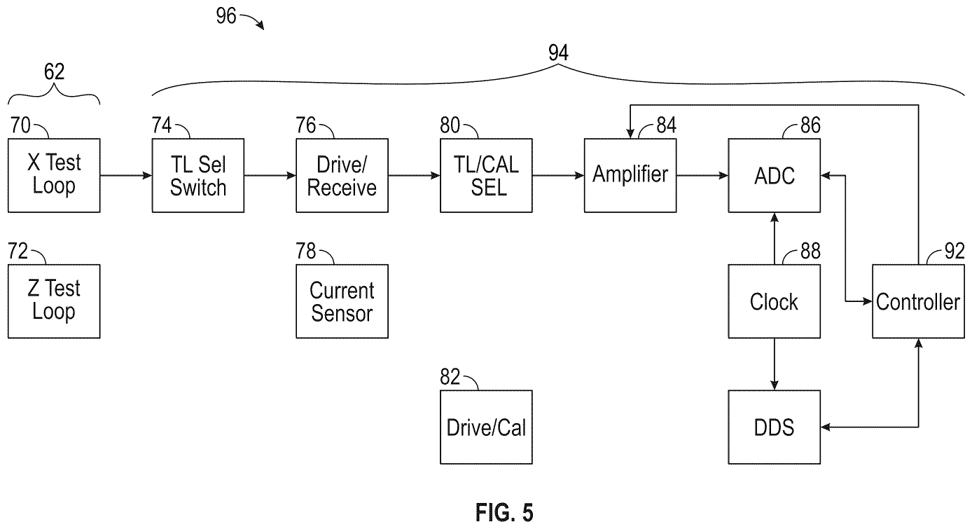

In drive mode, as in the illustrated embodiment, the drive/receive block 76 may feed the test signal from the current sensor 78 through the test loop select switch 74 to the test loop 62. As disclosed herein, the test loop select switch 74 may select whether the test signal is driven through the X test loop 70 or the Z test loop 72. While the test signal is driven through the X test loop 70 in FIGS. 4 and 5, it should be appreciated that the test signal may instead or in addition be driven through the Z test loop 72. Additionally, it should be appreciated that, although only two sub-loops are illustrated, the test loop 62 may include one sub-loop or three or more sub-loops. Using the test signal, the X test loop 70 may induce a voltage in the receiver 58.

The current sensor 78 also may drive the test signal through the test loop/calibration select switch 80 to the amplifier 84. The amplifier 84 may receive control signals from the controller 92 to adjust the gain of the amplifier 84. The amplifier 84 may apply the electronic gain to the test signal and feed it to the ADC 86. The controller 92 may provide one or more control signals to the ADC 86 to convert the test signal into a digital test signal. The ADC 86 may convert the test signal to a digital test signal and provide the digital test signal to the controller 92. The clock 88 may provide a timestamp to each of the DDS 90 and the ADC 86. The controller may use the timestamps output by the clock to synchronize a waveform of the test signal as generated by the DDS 90 to a waveform of the test signal as received by the ADC 86.

FIG. 5 depicts a diagram of the calibration system 96 receiving a test signal from the logging tool of FIG. 3a or FIG. 3b. In particular, the diagram depicts the test loop 62 receiving the test signal and providing the test signal to the electronics of the logging tool 32. This operation may be performed when calibrating the transmitter 60.

To begin, the test loop/calibration select switch 80 may be used to select a mode of operation of the calibration system 96. In the illustrated embodiment, the test loop/calibration select switch 80 is set to transmitter mode. When the calibration system 96 is in transmitter mode, the test loop select switch 74 may be used to determine which sub-loop of the test loop 62 the calibration system 96 employs.

The controller 92 outputs a command to the DDS 90 to generate the known test signal. The DDS 90 may provide the controller 92 an indication that it has generated the test signal. The DDS 90 may then provide the test signal to the transmitter 60. The test loop 62 may receive the test signal from the transmitter 60. In particular, in the illustrated embodiment, the X test loop 70 receives the test signal from the transmitter 60. The test signal may be driven through the test loop select switch 74 and received by the drive/receive block 76. The drive/receive block 76 may feed the test signal through the test loop/calibration select switch 80 to the amplifier 84. The amplifier 84 may receive control signals from the controller 92 to adjust the gain of the amplifier 84. The amplifier 84 may apply the electronic gain to the test signal and feed it to the ADC 86. The controller 92 may provide one or more control signals to the ADC 86 to convert the test signal into a digital test signal. The ADC 86 may convert the test signal to a digital test signal and provide the digital test signal to the controller 92. The controller may use the timestamps output by the clock to synchronize a waveform of the test signal as generated by the DDS 90 to a waveform of the test signal as received by the ADC 86.

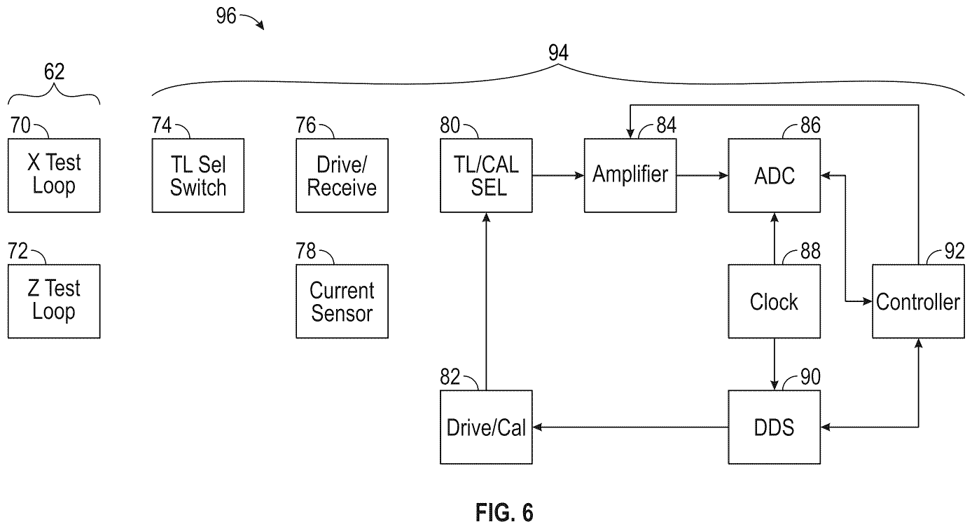

FIG. 6 depicts a diagram of the integrated calibration transceiver 94 of the calibration system of FIG. 4 performing self-calibration in conjunction with the logging tool of FIG. 3a or FIG. 3b. Self-calibration is used to calibrate the electronic gain output by the amplifier 84.

To begin, the test loop/calibration select switch 80 may be used to select a mode of operation of the calibration system 96. In the illustrated embodiment, the test loop/calibration select switch 80 is set to self-calibration mode.

The controller 92 instructs the DDS 90 to generate the test signal. The DDS 90 may provide the controller 92 an indication that it has generated the test signal. The drive calibration block 82 may feed the test signal from the DDS 90 through the test loop/calibration selection switch 80 to the amplifier 84. The amplifier 84 may receive control signals from the controller 92 indicating the gain of the amplifier 84. The amplifier 84 may apply the electronic gain to the test signal and feed it to the ADC 86. The controller 92 may provide one or more control signals to the ADC 86 to convert the test signal into a digital test signal. The ADC 86 may convert the test signal to a digital test signal and provide the digital test signal to the controller 92. The controller may use the timestamps output by the clock to synchronize a waveform of the test signal as generated by the DDS 90 to the waveform of the test signal as received by the ADC 86. The controller may compare the synchronized waveforms and determine whether the amplifier 84 applied the electronic gain as instructed. If not, the controller may adjust the instructions sent to the amplifier to ensure the desired electronic gain is applied. Self-calibration as described herein may reduce the accuracy and stability requirements for the EM acquisition system 54 by relying solely on the accuracy and stability of the integrated calibration transceiver 94. Additionally, because the calibration signal may be used for system level calibration, self-calibration may cancel out certain types of systematic errors.

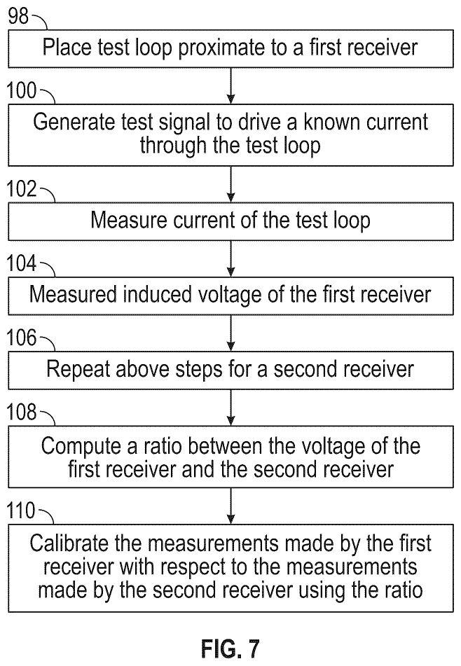

FIG. 7 depicts a flowchart of an embodiment for calibrating the receiver 58 using the calibration system 96 as disclosed herein. In process block 98, the test loop 62 may be connected to the external port 68 such that the test loop 62 is communicatively coupled to the integrated calibration transceiver 94 and placed proximate to a first receiver to be tested. In process block 100, the integrated calibration transceiver 94 may generate the test signal to drive a known current through the test loop 62. In process block 102, the current sensor 78 may measure the current of the test loop. In process block 104, the electronics of the tool 32 may measure the induced voltage of the first receiver. In process block 106, the process in process blocks 98, 100, 102, and 104 are repeated with a second receiver. That is to say, the test loop 62 may be placed proximate to the second receiver, the integrated calibration transceiver 94 may generate the test signal to drive a known current through the test loop 62, the current sensor 78 may measure the current of the test loop, and the electronics of the tool 32 may measure the induced voltage of the second receiver. In process block 108, the processor 50 of the tool 32 and/or the controller 92 of the integrated calibration transceiver 94 may compute the gain using a ratio of the induced voltage of the first receiver to the induced voltage of the second receiver as seen in the following equation:

$$g = \frac{{V}_{R 1}}{{V}_{R 2}} \cdot \frac{{V}_{TL 1}}{{V}_{TL 2}}$$

where g represents the gain of the first receiver with respect to the second receiver, V_{R1} and V_{R2} represent the induced voltage measurements of the first receiver and the second receiver respectively, and V_{TL1} and V_{TL2} represent the current driven through the test loop when calibrating the first receiver and the second receiver respectively. In process block 110, the measurements made by the first receiver are calibrated with respect to the measurements made by the second receiver using the ratio.

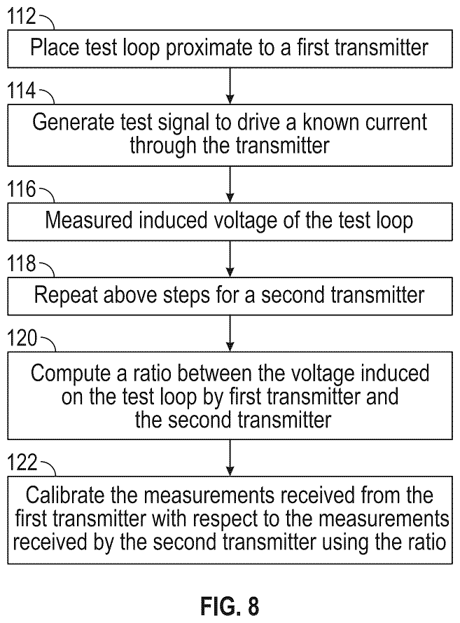

FIG. 8 depicts a flowchart of an embodiment for calibrating the transmitter 60 using the calibration system 96 as disclosed herein. In process block 112, the test loop 62 may be connected to the external port 68 such that the test loop 62 is communicatively coupled to the integrated calibration transceiver 94 and placed proximate to a first transmitter to be tested. In process block 114, the electronics of the tool 32 may generate the test signal to drive a known current through the first transmitter. In process block 116, the integrated calibration transceiver 94 may measure the induced voltage of the test loop 62. In process block 118, the process in process blocks 112, 114, and 116 are repeated with a second transmitter. That is to say, the test loop 62 may be placed proximate to the second transmitter, the electronics of the tool 32 may generate the test signal to drive a known current through the second transmitter, and the integrated calibration transceiver 94 may measure the induced voltage of the test loop. In process block 120, the processor 50 of the tool 32 and/or the controller 92 of the integrated calibration transceiver 94 may compute the gain using a ratio of the voltage induced on the test loop by the first transmitter to the voltage induced on the test loop by the second transmitter as seen in the following equation:

$$g = \frac{{V}_{T 1}}{{V}_{T 2}} \cdot \frac{{V}_{TL 1}}{{V}_{TL 2}}$$

where g represents the gain of the first transmitter with respect to the transmitter receiver, V_{T1} and V_{T2} represent the current driven through the first transmitter and the second transmitter respectively when calibrating, and V_{TL1} and V_{TL2} represent the voltage induced on the test loop when calibrating the first transmitter and the second transmitter respectively. In process block 122, the measurements made by the first transmitter are calibrated with respect to the measurements made by the second transmitter using the ratio.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A calibration system, comprising:
a test loop placed over one or more antennas of a logging tool;
an integrated calibration transceiver, wherein the integrated calibration transceiver is disposed in an electronic chassis of the logging tool; and
a port disposed in the logging tool and configured to receive a connector of the test loop to connect the test loop to the integrated calibration transceiver, wherein the integrated calibration transceiver is configured to generate a test signal to drive the test loop and receive the test signal from the test loop.

2. The calibration system of claim 1, wherein the integrated calibration transceiver comprises a controller.

3. The calibration system of claim 2, wherein the controller is configured to calibrate the integrated calibration transceiver via at least one control signal generated via the controller.

4. The calibration system of claim 1, wherein the one or more antennas comprise one or more receivers, one or more transmitters, or both.

5. The calibration system of claim 4, wherein the integrated calibration transceiver is configured to generate the test signal when the test loop is placed over the one or more receivers and wherein the integrated calibration transceiver is configured to receive the test signal when the test loop is placed over the one or more transmitters.

6. The calibration system of claim 1, wherein the integrated calibration transceiver is configured to switch between generating and receiving the test signal without adjusting the connector of the test loop.

7. The calibration system of claim 1, wherein the integrated calibration transceiver comprises a clock circuit configured to provide a clock signal utilized to synchronize operations on the test signal.

8. The calibration system of claim 1, wherein the test loop comprises one or more sub-loops.

9. A calibration system, comprising:
a test loop placed over one or more antennas of a logging tool;
an integrated calibration transceiver installed on an electronic chassis of the logging tool comprising:
a controller;
a clock configured to perform synchronization operations of the integrated calibration transceiver;
an amplifier coupled to the controller and configured to apply a gain to a test signal of the integrated calibration transceiver; and
a test loop/calibration select switch coupled to the amplifier and configured to provide the test signal to the amplifier; and
a port disposed in the logging tool and configured to receive a connector of the test loop to communicatively couple the test loop to the integrated calibration transceiver, wherein the integrated calibration transceiver is configured to generate the test signal to drive the test loop and receive the test signal from the test loop.

10. The calibration system of claim 9, wherein test loop/calibration select switch is configured to switch between a receiver mode, a transmitter mode, and a self-calibration mode.

11. The calibration system of claim 10, wherein the one or more antennas comprise a receiver, a transmitter, or both.

12. The calibration system of claim 9, wherein the logging tool comprises a memory coupled to the integrated calibration transceiver, wherein the memory is configured to store calibration data of the integrated calibration transceiver.

13. The calibration system of claim 9, wherein the integrated calibration transceiver is configured to switch between generating and receiving the test signal without adjusting the connector of the test loop.

14. A method, comprising:
obtaining first calibration data for a first antenna of a logging tool via an integrated calibration transceiver disposed in an electronic chassis of the logging tool;
obtaining second calibration data for a second antenna of the logging tool via the integrated calibration transceiver;
computing a ratio between the first calibration data and the second calibration data; and
calibrating the first antenna with respect to the second antenna using the ratio.

15. The method of claim 14, comprising performing a self-calibration of the integrated calibration transceiver when a test loop/calibration select switch of the logging tool is set to a self-calibration mode.

16. The method of claim 15, wherein performing the self-calibration of the integrated calibration transceiver comprises:
generating a test signal;
driving the test signal through an amplifier of the integrated calibration transceiver to generate an amplified test signal;
outputting the amplified test signal to a controller of the integrated calibration transceiver; and
calibrating gain of the amplifier based on a difference between the test signal and the amplified test signal.

17. The method of claim 14, comprising performing a calibration of the first antenna as a receiver when a test loop/calibration select switch of the logging tool is set to a receiver mode.

18. The method of claim 17, wherein performing the calibration of the first antenna comprises:
receiving a test signal from a test loop placed over the first antenna of the logging tool;
measuring a voltage of the test loop; and
storing the voltage of the test loop as calibration data.

19. The method of claim 14, comprising performing a calibration of the first antenna as a transmitter when a test loop/calibration select switch of the logging tool is set to a transmitter mode.

20. The method of claim 19, wherein performing the calibration of the first antenna comprises:
generating a test signal;
driving the test signal through a test loop placed over the first antenna of the logging tool;
measuring a current of the test signal; and
storing the current of the test signal as calibration data.
